(19) United States
(12) Patent Application Publication
(10) Pub. No.: US 2026/0011957 A1
(43) Pub. Date: Jan. 8, 2026

(54) ELECTRICAL CONNECTOR WITH IMPROVED GROUNDING ELEMENT AND METHOD OF MANUFACTURING THE SAME

(71) Applicant: DONGGUAN LUXSHARE TECHNOLOGIES CO., LTD, Dongguan City (CN)

(72) Inventor: Hongji CHEN, Dongguan City (CN)

(73) Assignee: DONGGUAN LUXSHARE TECHNOLOGIES CO., LTD, Dongguan City (CN)

(21) Appl. No.: 18/781,108

(22) Filed: Jul. 23, 2024

(30) Foreign Application Priority Data
Jul. 3, 2024 (CN) 202410888781.6

(51) Int. Cl. H01R 13/652; H01R 12/71; H01R 13/405; H01R 13/6582; H01R 43/24

(52) U.S. Cl. CPC H01R 13/652; H01R 12/716; H01R 13/405; H01R 13/6582; H01R 43/24

(57) ABSTRACT

An electrical connector includes a mounting body, a number of first conductive terminals and a first ground element. The first conductive terminals are directly or indirectly fixed to the mounting body. The first conductive terminals include a first signal conductive terminal, a first ground terminal and a second ground terminal. The first signal conductive terminal is located between the first ground terminal and the second ground terminal. The first ground element is formed by filling a first mold cavity with a flowing first electrical liquid. The first ground element is in contact with the first ground terminal and the second ground terminal, but is not in contact with the first signal conductive terminal. A method of manufacturing the electrical connector is also disclosed.

### CROSS-REFERENCE TO RELATED APPLICATION

This patent application claims priority of a Chinese Patent Application No. 202410888781.6, filed on Jul. 3, 2024 and titled “ELECTRICAL CONNECTOR AND METHOD OF MANUFACTURING THE SAME”, the entire content of which is incorporated herein by reference.

### TECHNICAL FIELD

The present disclosure relates to an electrical connector and a method of manufacturing the same, which belongs to the technical field of connectors.

### BACKGROUND

Electrical connectors in the related art generally include a mounting body, a terminal module mounted to the mounting body, and a shielding shell enclosing the mounting body. The terminal module includes a plurality of conductive terminals, a fixing block fixed on the plurality of conductive terminals, and a ground piece mounted to the fixing block. The plurality of conductive terminals include a plurality of signal terminals, a first ground terminal and a second ground terminal. The ground piece is provided with a first contact portion in contact with the first ground terminal and a second contact portion in contact with the second conductive terminal.

However, with the trend of miniaturization of electrical connectors, there is no enough space on the fixing block to install the ground piece.

Therefore, it is necessary to improve the electrical connector in the related art.

### SUMMARY

An object of the present disclosure is to provide an electrical connector with an improved grounding element and a method of manufacturing the same.

In order to achieve the above object, the present disclosure adopts the following technical solution: an electrical connector, including: a mounting body; a plurality of first conductive terminals, the plurality of first conductive terminals being directly or indirectly fixed to the mounting body; the plurality of first conductive terminals including at least one first signal conductive terminal, a first ground terminal and a second ground terminal; the at least one first signal conductive terminal being located between the first ground terminal and the second ground terminal along a first direction; and a first grounding element, the first grounding element being formed by filling a first mold cavity with a flowing first electrical liquid and solidifying the flowing first electrical liquid; the first grounding element being in contact with the first ground terminal and the second ground terminal, but not being in contact with the at least one first signal conductive terminal.

In order to achieve the above object, the present disclosure adopts the following technical solution: a method of manufacturing an electrical connector, electrical connector, including: a mounting body; a plurality of first conductive terminals, the plurality of first conductive terminals being directly or indirectly fixed to the mounting body; and a first grounding element; the method including: providing the mounting body; providing the plurality of first conductive terminals; the plurality of first conductive terminals including at least one first signal conductive terminal, a first ground terminal and a second ground terminal; the at least one first signal conductive terminal being located between the first ground terminal and the second ground terminal along a first direction; and filling a flowing first electrical liquid into the first mold cavity; the flowing first electrical liquid forming the first grounding element after solidifying; the first ground element being in contact with the first ground terminal and the second ground terminal, but not being in contact with the at least one first signal conductive terminal.

Compared with the prior art, the present disclosure forms the first ground element by filling the flowing first electrical liquid into the first mold cavity and solidifying the first electrical liquid. The first ground element is in contact with the first ground terminal and the second ground terminal, but is not in contact with the first signal conductive terminal. With this arrangement, the present disclosure avoids the inconvenience caused by assembling the first ground element in the related art.

### BRIEF DESCRIPTION OF DRAWINGS

FIG. 1 is a schematic perspective view of an electrical connector in accordance with an embodiment of the present disclosure;

FIG. 2 is a perspective view of FIG. 1 from another angle;

FIG. 3 is a partially exploded perspective view of FIG. 1;

FIG. 4 is a partially exploded perspective view of FIG. 3 from another angle;

FIG. 5 is a further exploded perspective view of FIG. 3;

FIG. 6 is an exploded perspective view of FIG. 5 from another angle;

FIG. 7 is a partially exploded perspective view of a first terminal module and a second terminal module in FIG. 5;

FIG. 8 is a partial enlarged view of a frame part B in FIG. 7;

FIG. 9 is a partial enlarged view of a frame part C in FIG. 7;

FIG. 10 is a partially exploded perspective view of FIG. 7 from another angle;

FIG. 11 is a further exploded perspective view of FIG. 7;

FIG. 12 is an exploded perspective view of FIG. 11 from another angle;

FIG. 13 is a schematic cross-sectional view taken along line D-D in FIG. 1;

FIG. 14 is a partially exploded perspective view of FIG. 7 in accordance with a second embodiment of the present disclosure;

FIG. 15 is a partial enlarged view of a frame part E in FIG. 14;

FIG. 16 is a partial enlarged view of a frame part F in FIG. 14;

FIG. 17 is a partially exploded perspective view of FIG. 14 from another angle;

FIG. 18 is a further exploded perspective view of FIG. 14;

FIG. 19 is an exploded perspective view of FIG. 18 from another angle; and

FIG. 20 is a schematic cross-sectional view of FIG. 13 in accordance with the second embodiment of the present disclosure.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

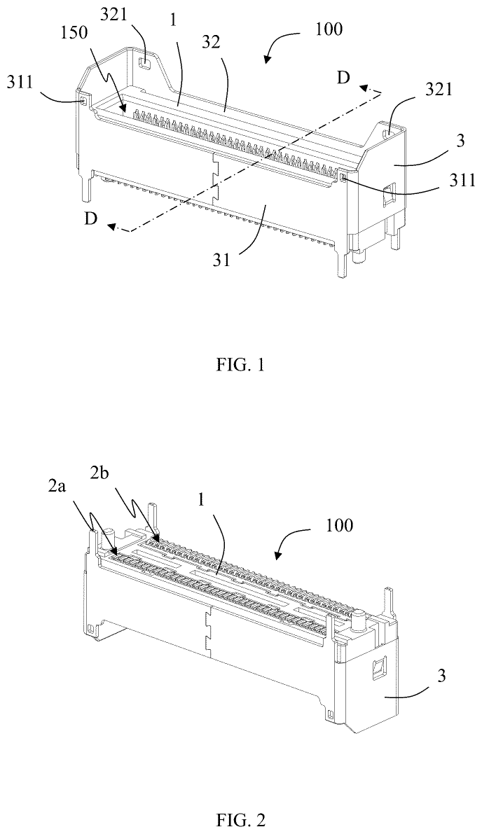

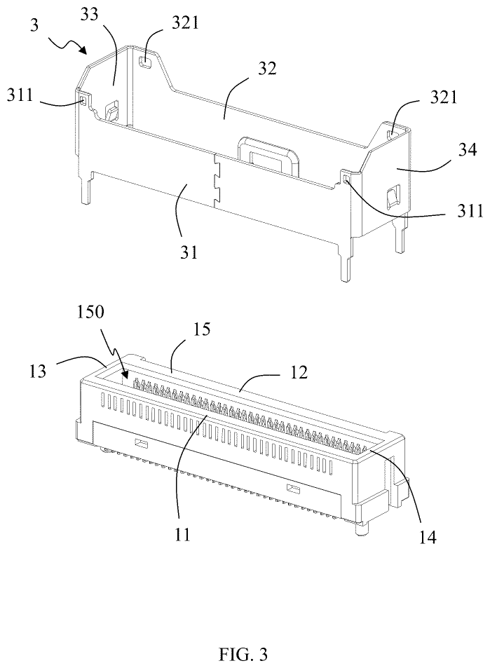

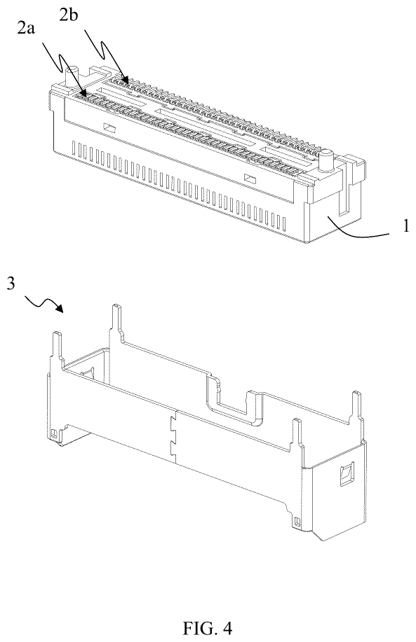

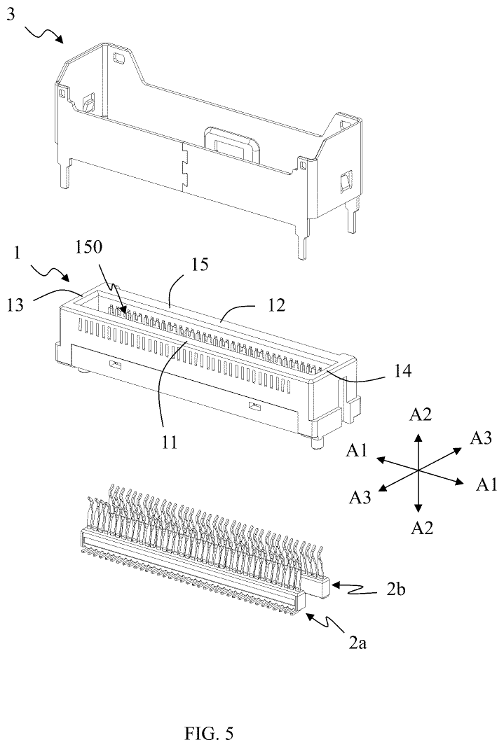

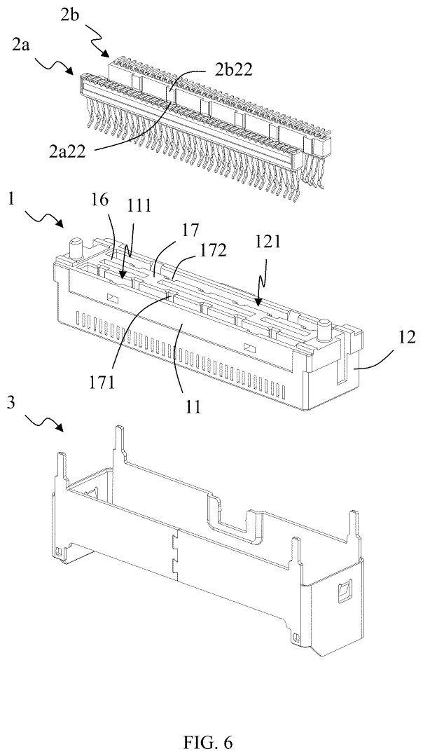

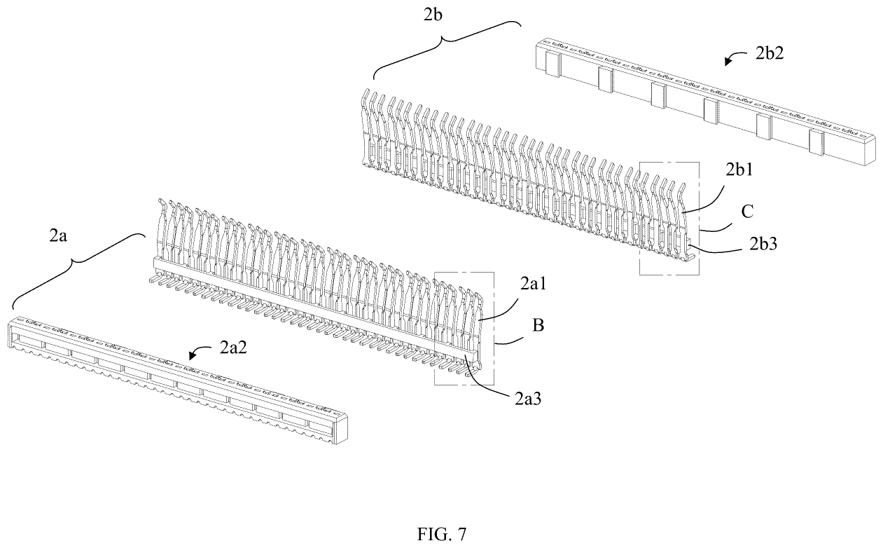

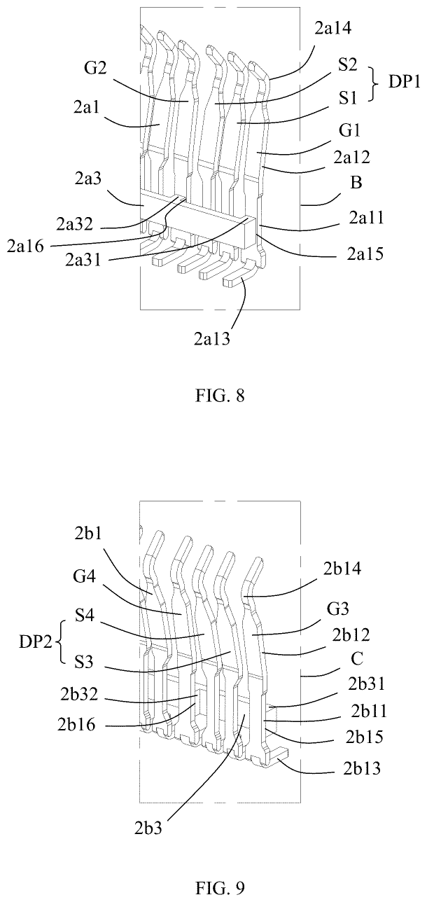

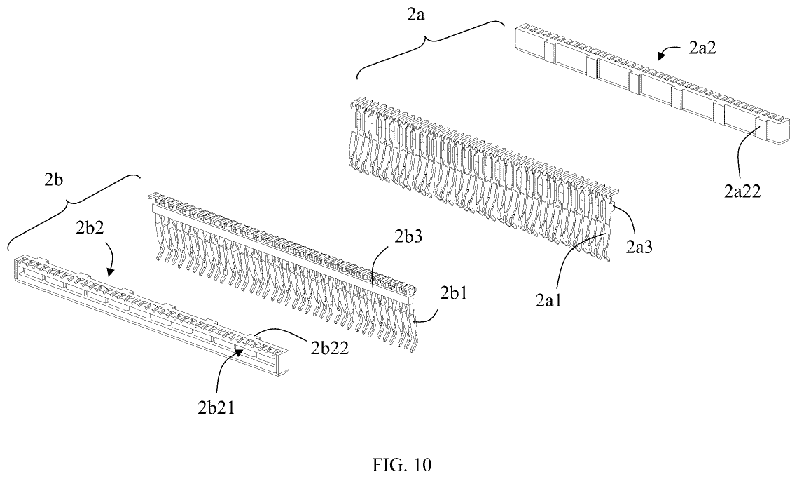

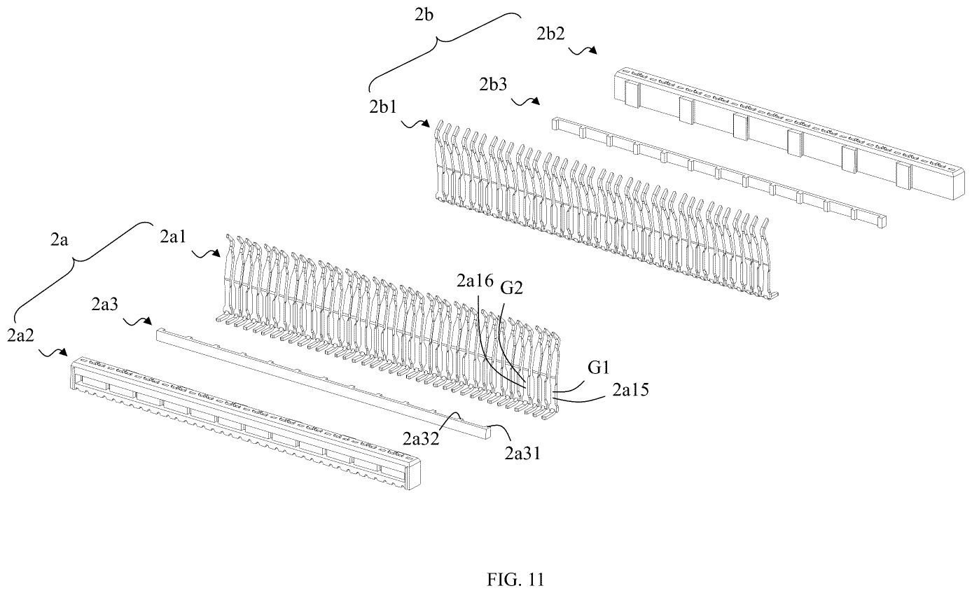

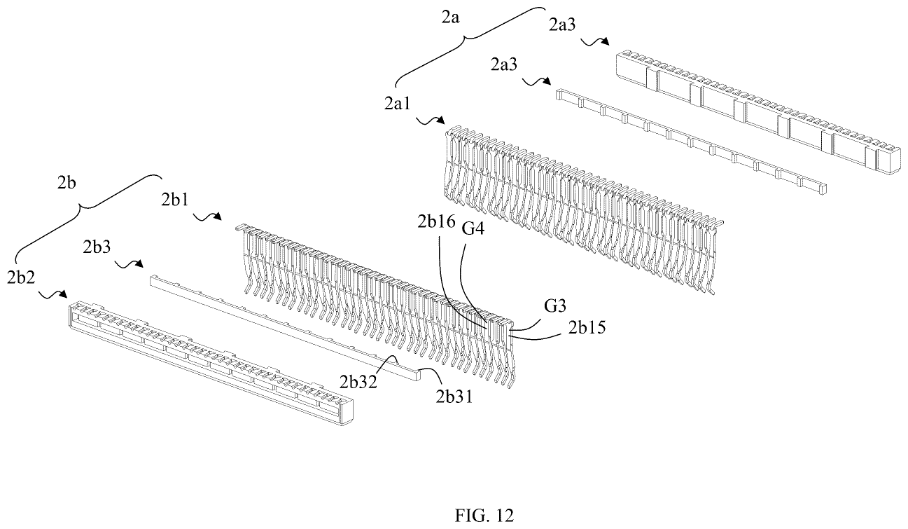

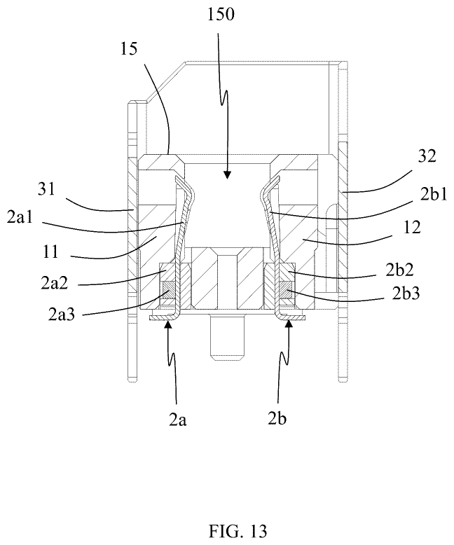

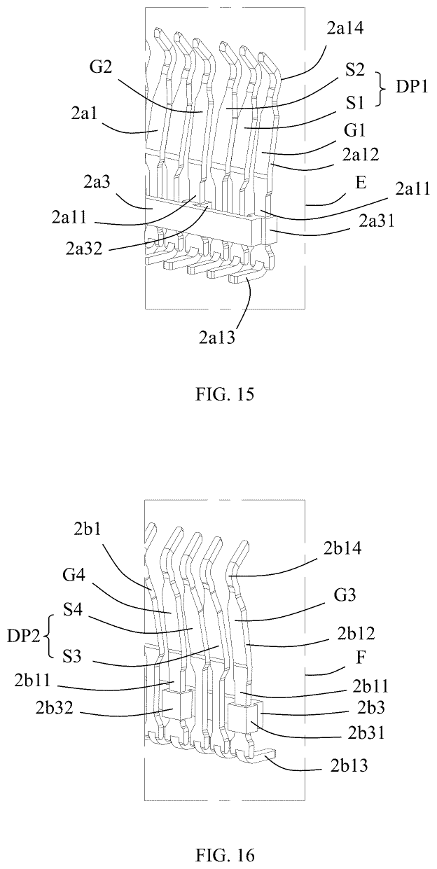

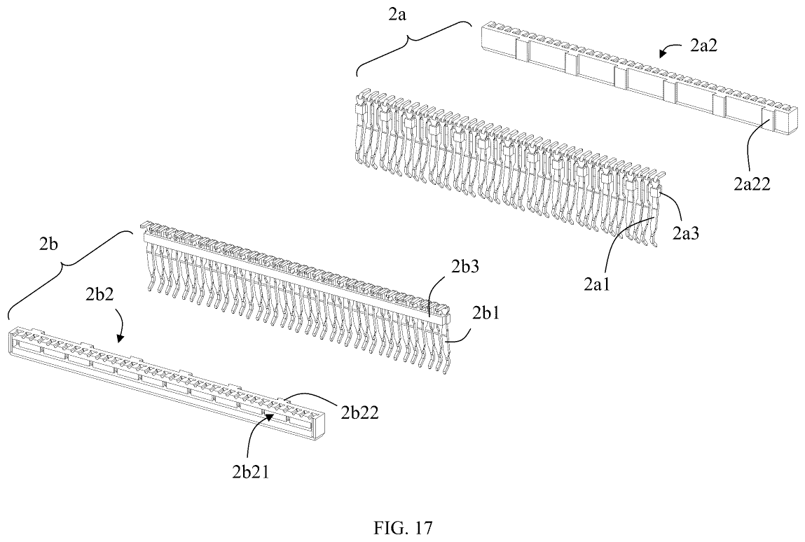

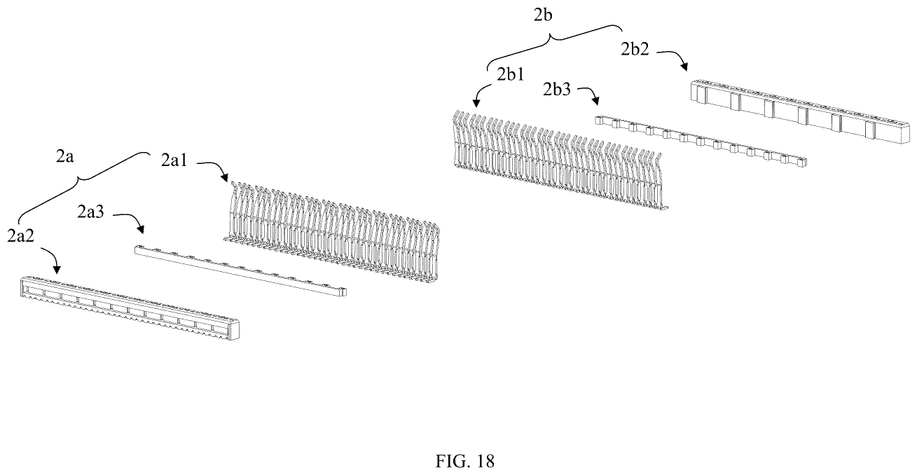

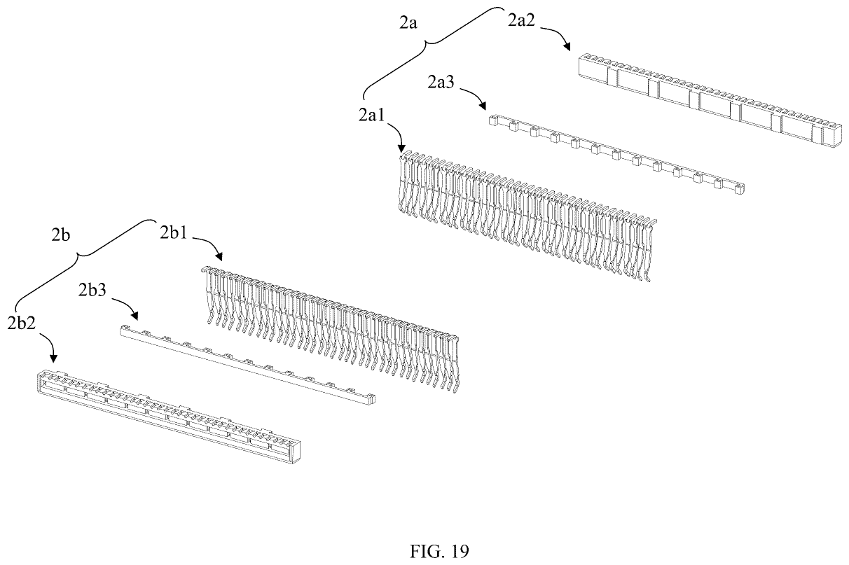

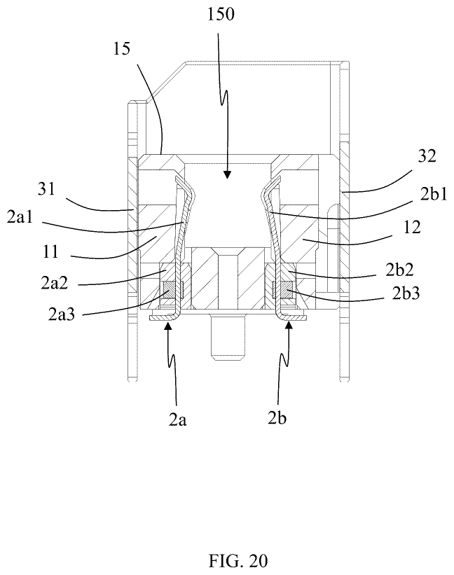

Referring to FIG. 1 to FIG. 20, the present disclosure discloses an electrical connector 100 and a method of manufacturing the electrical connector 100. The electrical connector 100 is configured to be mounted on a circuit board (not shown) and for mating with a mating connector (not shown). The electrical connector 100 includes a mounting body 1, a first terminal module 2a mounted to the mounting body 1, a second terminal module 2b mounted to the mounting body 1, and a shielding shell 3 enclosing the mounting body 1.

In the illustrated embodiment of the present disclosure, the mounting body 1 is made of insulating material. The mounting body 1 includes a mating surface 15, a mounting surface 16 opposite to the mating surface 15, and a mating slot 150 extending through the mating surface 15 along a second direction A2-A2 (for example, a top-bottom direction). The mating slot 150 is configured to at least partially receive the mating connector.

The mounting body 1 includes a first side wall 11, a second side wall 12 opposite to the first side wall 11, a third side wall 13 connecting one end of the first side wall 11 and one end of the second side wall 12, and a fourth side wall 14 connecting another end of the first side wall 11 and another end of the second side wall 12. The mating slot 150 is surrounded by the first side wall 11, the second side wall 12, the third side wall 13 and the fourth side wall 14. Along a first direction A1-A1 (for example, a left-right direction), the mating slot 150 is located between the third side wall 13 and the fourth side wall 14. Along a third direction A3-A3 (for example, a front-rear direction), the mating slot 150 is located between the first side wall 11 and the second side wall 12. Each two of the first direction A1-A1, the second direction A2-A2 and the third direction A3-A3 are perpendicular to each other.

In the illustrated embodiment of the present disclosure, the mounting body 1 further includes a bottom wall 17 located at a bottom of the mating slot 150. The mounting surface 16 is provided on the bottom wall 17. The first side wall 11 further defines a first mounting slot 111 which extends through the bottom wall 17 along the second direction A2-A2 and communicates with the mating slot 150. The second side wall 12 further defines a second mounting slot 121 that extends through the bottom wall 17 along the second direction A2-A2 and communicates with the mating slot 150. In the illustrated embodiment of the present disclosure, the bottom wall 17 is provided with a plurality of first dovetail grooves 171 communicating with the first mounting slot 111 and a plurality of second dovetail grooves 172 communicating with the second mounting slot 121. The first mounting slot 111 and the plurality of first dovetail grooves 171 are configured to install the first terminal module 2a. The second mounting slot 121 and the plurality of second dovetail grooves 172 are configured to install the second terminal module 2b.

In the illustrated embodiment of the present disclosure, the first terminal module 2a includes a plurality of first conductive terminals 2al and a first fixing block 2a2 fixed on the plurality of first conductive terminals 2a1. The first fixing block 2a2 is inserted into the first mounting slot 111. The plurality of first conductive terminals 2al are directly or indirectly fixed to the mounting body 1. In an embodiment of the present disclosure, the plurality of first conductive terminals 2al are fixed to the first fixing block 2a2 by insert-molding. Of course, it is understandable to those skilled in the art that the plurality of first conductive terminals 2al can also be fixed to the first fixing block 2a2 by assembly. Alternatively, the plurality of first conductive terminals 2al are directly assembled and fixed to the mounting body 1, and the first fixing block 2a2 is omitted.

In the illustrated embodiment of the present disclosure, the plurality of first conductive terminals 2al include a plurality of first signal conductive terminals, a plurality of first ground terminals G1 and a plurality of second ground terminals G2. In the illustrated embodiment of the present disclosure, the plurality of first signal conductive terminals include a plurality of first signal terminal pairs DP1. Each first signal terminal pair DP1 includes a first signal terminal S1 and a second signal terminal S2. In an embodiment of the present disclosure, the first signal terminal S1 and the second signal terminal S2 form a differential pair. In order to improve shielding, in the illustrated embodiment of the present disclosure, one first ground terminal G1 and one second ground terminal G2 are provided on two sides of each first signal terminal pair DP1, respectively. The first ground terminal G1, the first signal terminal S1, the second signal terminal S2 and the second ground terminal G2 are disposed sequentially and adjacently along the first direction A1-A1.

Each first conductive terminal 2a1 includes a first fixing portion 2a11 at least partially fixed to the first fixing block 2a2, a first elastic arm portion 2a12 extending from one end of the first fixing portion 2a11, and a first tail portion 2a13 extending from another end of the first fixing portion 2a11. The first elastic arm portion 2a12 is provided with a first contact portion 2a14 that protrudes into the mating slot 150. The first contact portion 2a14 is configured to be in electrical contact with the mating connector. The first tail portion 2a13 is exposed to the mounting surface 16 to be configured to be mounted on the circuit board. In the illustrated embodiment of the present disclosure, the first tail portion 2a13 is vertically bent outwardly compared to the first fixing portion 2a11. The first tail portion 2a13 extends along the third direction A3-A3. The first tail portion 2a13 is configured to be fixed to the circuit board by Surface Mounting Technology (SMT).

In one embodiment of the present disclosure, the first fixing block 2a2 is provided with a plurality of first dovetail protrusions 2a22 for being fixed in the plurality of first dovetail grooves 171.

In the illustrated embodiment of the present disclosure, the electrical connector 100 further includes a first ground element 2a3. The first ground element 2a3 is formed by filling a first mold cavity 2a21 with a flowing first electrical liquid and solidifying the first electrical liquid. The first ground element 2a3 is in contact with the first ground terminal G1 and the second ground terminal G2 to increase the grounding area and improve the ground shielding effect. The first ground element 2a3 is not in contact with the first signal conductive terminals (for example, the first signal terminal S1 and the second signal terminal S2) to avoid short circuit.

In the illustrated embodiment of the present disclosure, the first mold cavity 2a21 is provided in the first fixing block 2a2. The first mold cavity 2a21 laterally extends through a surface of the first fixing block 2a2 along the third direction A3-A3.

It is understandable to those skilled in the art that in other embodiments, the first mold cavity 2a21 may be provided in other components. For example, a mold is used and the first mold cavity 2a21 is provided in the mold. The first ground element 2a3 is formed by filling the flowing first electrical liquid into the first mold cavity 2a21 and solidifying the first electrical liquid. At this time, the first ground element 2a3 is in contact with the first ground terminal G1 and the second ground terminal G2, and forms an integral piece. Then, the integral piece is fixed to the first fixing block 2a2, and the first terminal module 2a of the present disclosure can also be obtained.

In the illustrated embodiment of the present disclosure, the first fixing portion 2a11 of the first ground terminal G1 and the first fixing portion 2a11 of the second ground terminal G2 are both at least partially exposed in the first mold cavity 2a21 before the first electrical liquid is filled. The first ground element 2a3 is provided with a first protrusion 2a31 and a second protrusion 2a32 after solidifying. The first protrusion 2a31 is in contact with the first fixing portion 2a11 of the first ground terminal G1. The second protrusion 2a32 is in contact with the first fixing portion 2a11 of the second ground terminal G2.

In an embodiment of the present disclosure, the first fixing portion 2a11 of the first ground terminal G1 is provided with a first contact surface 2a15. The first fixing portion 2a11 of the second ground terminal G2 is provided with a second contact surface 2a16. The first protrusion 2a31 is in contact with the first contact surface 2a15. The second protrusion 2a32 is in contact with the second contact surface 2a16.

In an embodiment of the present disclosure, in order to maintain contact reliability, the first protrusion 2a31 and the first contact surface 2a15 are integrated into one piece, and the second protrusion 2a32 and the second contact surface 2a16 are integrated into one piece.

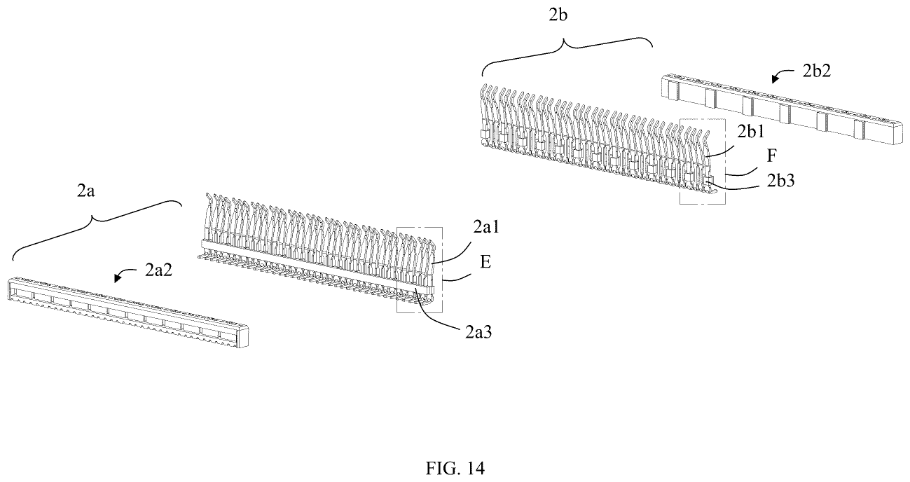

As shown in FIG. 14 to FIG. 20, in another embodiment of the present disclosure, in order to improve contact reliability and increase the grounding area, the first protrusion 2a31 circumferentially wraps around the first fixing portion 2a11 of the first ground terminal G1; the second protrusion 2a31 circumferentially wraps around the first fixing portion 2a11 of the second ground terminal G2.

Similarly, in the illustrated embodiment of the present disclosure, the second terminal module 2b includes a plurality of second conductive terminals 2b1 and a second fixing block 2b2 fixed on the plurality of second conductive terminals 2b1. The second fixing block 2b2 is inserted into the second mounting slot 121. The plurality of second conductive terminals 2b1 are directly or indirectly fixed to the mounting body 1. In one embodiment of the present disclosure, the plurality of second conductive terminals 2b1 are fixed to the second fixing block 2b2 by insert-molding. Of course, it is understandable to those skilled in the art that the plurality of second conductive terminals 2b1 can also be fixed to the second fixing block 2b2 by assembly. Alternatively, the plurality of second conductive terminals 2b1 are directly assembled and fixed to the mounting body 1, and the second fixing block 2b2 is omitted.

In the illustrated embodiment of the present disclosure, the plurality of second conductive terminals 2b1 include a plurality of second signal conductive terminals, a plurality of third ground terminals G3 and a plurality of fourth ground terminals G4. In the illustrated embodiment of the present disclosure, the plurality of second signal conductive terminals include a plurality of second signal terminal pairs DP2. Each second signal terminal pair DP2 includes a third signal terminal S3 and a fourth signal terminal S4. In an embodiment of the present disclosure, the third signal terminal S3 and the fourth signal terminal S4 form a differential pair. In order to improve shielding, in the illustrated embodiment of the present disclosure, one third ground terminal G3 and one fourth ground terminal G4 are provided on two sides of each second signal terminal pair DP2, respectively. The third ground terminal G3, the third signal terminal S3, the fourth signal terminal S4 and the fourth ground terminal G4 are disposed sequentially and adjacently along the first direction A1-A1.

Each second conductive terminal 2b1 includes a second fixing portion 2b11 at least partially fixed to the second fixing block 2b2, a second elastic arm portion 2b12 extending from one end of the second fixing portion 2b11, and a second tail portion 2b13 extending from another end of the second fixing portion 2b11. The second elastic arm portion 2b 12 is provided with a second contact portion 2b 14 that protrudes into the mating slot 150. The second contact portion 2b14 is configured to be in electrical contact with the mating connector. The second tail portion 2b13 is exposed to the mounting surface 16 to be configured to be mounted on the circuit board. In the illustrated embodiment of the present disclosure, the second tail portion 2b13 is bent vertically outwardly compared to the second fixing portion 2b11. The second tail portion 2b13 extends along the third direction A3-A3. The second tail portion 2b13 is configured to be fixed on the circuit board through Surface Mounting Technology (SMT).

In one embodiment of the present disclosure, the second fixing block 2b2 is provided with a plurality of second dovetail protrusions 2b22 for being fixed in the plurality of second dovetail grooves 172.

In the illustrated embodiment of the present disclosure, the electrical connector 100 further includes a second ground element 2b3. The second ground element 2b3 is formed by filling a second mold cavity 2b21 with a flowing second electrical liquid and solidifying the second electrical liquid. The second ground element 2b3 is in contact with the third ground terminal G3 and the fourth ground terminal G4 to increase the grounding area and improve the ground shielding effect. The second ground element 2b3 is not in contact with the second signal conductive terminals (for example, the third signal terminal S3 and the fourth signal terminal S4) to avoid short circuit.

In the illustrated embodiment of the present disclosure, the second mold cavity 2b21 is provided in the second fixing block 2b2. The second mold cavity 2b21 laterally extends through a surface of the second fixing block 2b2 along the third direction A3-A3.

It is understandable to those skilled in the art that in other embodiments, the second mold cavity 2b21 can be provided in other components. For example, a mold is used and the second mold cavity 2b21 is provided in the mold. The second ground element 2b3 is formed by filling the flowing second electrical liquid into the second mold cavity 2b21 and solidifying the second electrical liquid. At this time, the second ground element 2b3 is in contact with the third ground terminal G3 and the fourth ground terminal G4 and forms an integral piece. Then, the integral piece is fixed to the second fixing block 2b2, and the second terminal module 2b of the present disclosure can also be obtained.

In the illustrated embodiment of the present disclosure, the second fixing portion 2b11 of the third ground terminal G3 and the second fixing portion 2b11 of the fourth ground terminal G4 are both at least partially exposed in the second mold cavity 2b21 before the second electrical liquid is filled. The second ground element 2b3 is provided with a third protrusion 2b31 and a fourth protrusion 2b32 after solidifying. The third protrusion 2b31 is in contact with the second fixing portion 2b11 of the third ground terminal G3. The fourth protrusion 2b32 is in contact with the second fixing portion 2b11 of the fourth ground terminal G4.

In an embodiment of the present disclosure, the second fixing portion 2b11 of the third ground terminal G3 is provided with a third contact surface 2b15. The second fixing portion 2b11 of the fourth ground terminal G4 is provided with a fourth contact surface 2b16. The third protrusion 2b31 is in contact with the third contact surface 2b15. The fourth protrusion 2b32 is in contact with the fourth contact surface 2b16.

In an embodiment of the present disclosure, in order to maintain contact reliability, the third protrusion 2b31 and the third contact surface 2b15 are integrated into one piece; and the fourth protrusion 2b32 and the fourth contact surface 2b16 are integrated into one piece.

As shown in FIG. 14 to FIG. 20, in another embodiment of the present disclosure, in order to improve contact reliability and increase the grounding area, the third protrusion 2b31 circumferentially wraps around the second fixing portion 2b11 of the third ground terminal G3. The second protrusion 2a31 circumferentially wraps around the second fixing portion 2b11 of the fourth ground terminal G4.

The shielding shell 3 is made of metal material and encloses the mounting body 1. The shielding shell 3 includes a first wall portion 31, a second wall portion 32 opposite to the first wall portion 31, a third wall portion 33 connecting one end of the first wall portion 31 and one end of the second wall portion 32, and a fourth wall portion 34 connecting another end of the first wall portion 31 and another end of the second wall portion 32. In the illustrated embodiment of the present disclosure, the first wall portion 31 is in contact with the first side wall 11; the second wall portion 32 is in contact with the second side wall 12; the third wall portion 33 is in contact with the third side wall 13; the fourth wall portion 34 is in contact with the fourth side wall 14. In the illustrated embodiment of the present disclosure, both sides of the first wall portion 31 and both sides of the second wall portion 32 protrude beyond the mating surface 15. The first wall portion 31 defines at least one first locking hole 311. The second wall portion 32 defines at least one second locking hole 321. The first locking hole 311 and the second locking hole 321 are both configured to lock with the mating connector. In the illustrated embodiment of the present disclosure, two first locking holes 311 and two second locking holes 321 are provided to improve the reliability when locking with the mating connector.

Compared with the prior art, the present disclosure forms the first ground element 2a3 by filling the flowing first electrical liquid into the first mold cavity 2a21 and solidifying the first electrical liquid. The first ground element 2a3 is in contact with the first ground terminal G1 and the second ground terminal G2, but is not in contact with the first signal conductive terminal. The arrangement of the first mold cavity 2a21 can be relatively flexible, which is beneficial to adapting to a small space, thereby facilitating the miniaturization of the electrical connector 100. Besides, the present disclosure avoids the inconvenience caused by assembling the first ground element 2a3 in the related art.

Similarly, in the present disclosure, the second ground element 2b3 is formed by filling the flowing second electrical liquid into the second mold cavity 2b21 and solidifying the second electrical liquid. The second ground element 2b3 is in contact with the third ground terminal G3 and the fourth ground terminal G4, but is not in contact with the second signal conductive terminal. The arrangement of the second mold cavity 2b21 can be relatively flexible, which is beneficial to adapting to a small space, thereby facilitating the miniaturization of the electrical connector 100. Besides, the present disclosure avoids the inconvenience caused by assembling the second ground element 2b3 in the related art.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
a mounting body;
a plurality of first conductive terminals, the plurality of first conductive terminals being directly or indirectly fixed to the mounting body; the plurality of first conductive terminals comprising at least one first signal conductive terminal, a first ground terminal and a second ground terminal; the at least one first signal conductive terminal being located between the first ground terminal and the second ground terminal along a first direction; and
a first grounding element, the first grounding element being formed by filling a first mold cavity with a flowing first electrical liquid and solidifying the flowing first electrical liquid; the first grounding element being in contact with the first ground terminal and the second ground terminal, but not being in contact with the at least one first signal conductive terminal.

2. The electrical connector according to claim 1, wherein the at least one first signal conductive terminal comprises a first signal terminal and a second signal terminal; the first signal terminal and the second signal terminal form a first signal terminal pair; the first signal terminal pair is located between the first ground terminal and the second ground terminal; the first ground terminal, the first signal terminal, the second signal terminal and the second ground terminal are disposed sequentially and adjacently along the first direction.

3. The electrical connector according to claim 2, further comprising a first terminal module; wherein the first terminal module comprises the plurality of first conductive terminals and a first fixing block fixed on the plurality of first conductive terminals; the first mold cavity is provided in the first fixing block.

4. The electrical connector according to claim 3, wherein each first conductive terminal comprises a first fixing portion at least partially fixed to the first fixing block;
the first fixing portion of the first ground terminal and the first fixing portion of the second ground terminal are both at least partially exposed in the in the first mold cavity before the first electrical liquid is filled;
the first grounding element comprises a first protrusion and a second protrusion after solidifying; the first protrusion is in contact with the first fixing portion of the first ground terminal; the second protrusion is in contact with the first fixing portion of the second ground terminal.

5. The electrical connector according to claim 4, wherein the first fixing portion of the first ground terminal is provided with a first contact surface; the first protrusion is in contact with the first contact surface;
the first fixing portion of the second ground terminal is provided with a second contact surface; the second protrusion is in contact with the second contact surface.

6. The electrical connector according to claim 5, wherein the first protrusion and the first contact surface are integrated into one piece; the second protrusion and the second contact surface are integrated into one piece.

7. The electrical connector according to claim 4, wherein the first protrusion circumferentially wraps around the first fixing portion of the first ground terminal; the second protrusion circumferentially wraps around the first fixing portion of the second ground terminal.

8. The electrical connector according to claim 4, wherein the mounting body comprises a mating surface, a mounting surface opposite to the mating surface, and a mating slot extending through the mating surface along a second direction; the mating slot is configured to at least partially receive a mating connector; the second direction is perpendicular to the first direction;
each first conductive terminal comprises a first elastic arm portion extending from one end of the first fixing portion and a first tail portion extending from another end of the first fixing portion; the first elastic arm portion is provided with a first contact portion protruding into the mating slot; the first contact portion is configured to be in electrical contact with the mating connector; the first tail portion is exposed to the mounting surface and is configured to be mounted on a circuit board.

9. The electrical connector according to claim 8, wherein the mounting body comprises a first side wall and a second side wall opposite to the first side wall; the mating slot is located between the first side wall and the second side wall along a third direction; the third direction is perpendicular to the first direction and the second direction;
the first side wall defines a first mounting slot in which the first terminal module is installed.

10. The electrical connector according to claim 1, further comprising:
a plurality of second conductive terminals, the plurality of second conductive terminals being directly or indirectly fixed to the mounting body; the plurality of second conductive terminals comprising at least one second signal conductive terminal, a third ground terminal and a fourth ground terminal; the at least one second signal conductive terminal being located between the third ground terminal and the fourth ground terminal along the first direction; and
a second grounding element, the second grounding element being formed by filling a second mold cavity with a flowing second electrical liquid and solidifying the flowing second electrical liquid; the second grounding element being in contact with the third ground terminal and the fourth ground terminal, but being not in contact with the at least one second signal conductive terminal.

11. The electrical connector according to claim 10, wherein the at least one second signal conductive terminal comprises a third signal terminal and a fourth signal terminal; the third signal terminal and the fourth signal terminal form a second signal terminal pair; the second signal terminal pair is located between the third ground terminal and the fourth ground terminal; the third ground terminal, the third signal terminal, the fourth signal terminal and the fourth ground terminal are disposed sequentially and adjacently along the first direction.

12. The electrical connector according to claim 11, further comprising a second terminal module; wherein the second terminal module comprises the plurality of second conductive terminals and a second fixing block fixed on the plurality of second conductive terminals; the second mold cavity is provided in the second fixing block.

13. The electrical connector according to claim 12, wherein each second conductive terminal comprises a second fixing portion at least partially fixed to the second fixing block;
the second fixing portion of the third ground terminal and the second fixing portion of the fourth ground terminal are both at least partially exposed in the second mold cavity before the second electrical liquid is filled;
a second grounding element is provided with a third protrusion and a fourth protrusion after solidifying; the third protrusion is in contact with the second fixing portion of the third ground terminal; the fourth protrusion is in contact with the second fixing portion of the fourth ground terminal.

14. The electrical connector according to claim 13, wherein the second fixing portion of the third ground terminal is provided with a third contact surface; the third protrusion is in contact with the third contact surface;
the second fixing portion of the fourth ground terminal is provided with a fourth contact surface; the fourth protrusion is in contact with the fourth contact surface.

15. The electrical connector according to claim 14, wherein the third protrusion and the third contact surface are integrated into one piece; the fourth protrusion and the fourth contact surface are integrated into one piece.

16. The electrical connector according to claim 13, wherein the third protrusion circumferentially wraps around the second fixing portion of the third ground terminal; the fourth protrusion circumferentially wraps around the second fixing portion of the fourth ground terminal.

17. The electrical connector according to claim 1, further comprising a shielding shell enclosing the mounting body; wherein the shielding shell comprises a first wall portion and a second wall portion opposite to the first wall portion; the first wall portion defines at least one first locking hole; the second wall portion defines at least one second locking hole; the first locking hole and the second locking hole are both configured to lock with a mating connector.

18. A method of manufacturing an electrical connector, the electrical connector comprising:
a mounting body;
a plurality of first conductive terminals, the plurality of first conductive terminals being directly or indirectly fixed to the mounting body; and
a first grounding element;
the method comprising:
providing the mounting body;
providing the plurality of first conductive terminals; the plurality of first conductive terminals comprising at least one first signal conductive terminal, a first ground terminal and a second ground terminal; the at least one first signal conductive terminal being located between the first ground terminal and the second ground terminal along a first direction; and
filling a flowing first electrical liquid into the first mold cavity; the flowing first electrical liquid forming the first grounding element after solidifying; the first ground element being in contact with the first ground terminal and the second ground terminal, but not being in contact with the at least one first signal conductive terminal.

19. The method according to claim 18, wherein the at least one first signal conductive terminal comprises a first signal terminal and a second signal terminal; the first signal terminal and the second signal terminal form a first signal terminal pair; the first signal terminal pair is located between the first ground terminal and the second ground terminal; the first ground terminal, the first signal terminal, the second signal terminal and the second ground terminal are disposed sequentially and adjacently along the first direction;
the electrical connector further comprises a first terminal module; wherein the first terminal module comprises the plurality of first conductive terminals and a first fixing block fixed on the plurality of first conductive terminals; the first mold cavity is provided in the first fixing block;
each first conductive terminal comprises a first fixing portion at least partially fixed to the first fixing block;
the first fixing portion of the first ground terminal and the first fixing portion of the second ground terminal are both at least partially exposed in the in the first mold cavity before the first electrical liquid is filled;
the first grounding element comprises a first protrusion and a second protrusion after solidifying; the first protrusion is in contact with the first fixing portion of the first ground terminal; the second protrusion is in contact with the first fixing portion of the second ground terminal.

20. The method according to claim 19, wherein the first protrusion circumferentially wraps around the first fixing portion of the first ground terminal; the second protrusion circumferentially wraps around the first fixing portion of the second ground terminal.
